(19) United States
(12) Patent Application Publication
(10) Pub. No.: US 2016/0161687 A1
(43) Pub. Date: Jun. 9, 2016

(54) OPTICAL CONNECTOR ALIGNMENT

(71) Applicant: HEWLETT-PACKARD DEVELOPMENT COMPANY, L.P., Houston, TX (US)

(72) Inventors: Paul Kessler Rosenberg, Sunnyvale, CA (US); Jason H. Culler, Livermore, CO (US); Sagi Varghese Mathai, Sunnyvale, CA (US); Michael Renne Ty Tan, Menlo Park, CA (US)

(21) Appl. No.: 14/904,010

(22) PCT Filed: Jul. 31, 2013
(86) PCT No.: PCT/US2013/052802

§ 371 Date: Jan. 8, 2016

(51) Int. Cl. G02B 6/42; G02B 6/30; G02B 6/12

(52) U.S. Cl. CPC G02B 6/4231; G02B 6/4292; G02B 6/4227; G02B 6/12004; G02B 6/30; G02B 6/4221

(57) ABSTRACT

An example apparatus comprises an optical connector coupled to at least one optical fiber cable; an optical interface coupled to the optical connector and to the at least one optical fiber cable, the optical interface to receive or transmit an optical signal; and an alignment collar releasably coupled to the optical connector and coupled to a substrate, wherein the optical interface is in alignment with at least one optical device coupled to the substrate.

### BACKGROUND

Fiber optic interconnections are being miniaturized and moved into closer proximity to integrated circuits. In some cases, optical engines (e.g., devices for translating electronic signals to light signals, and light signals to electronic signals) including active optical elements such as lasers and photodiodes can be soldered directly to the surface of semi-conductors (e.g., a flip chip configuration) in order to improve signal integrity and to increase physical density. This co-packaged assembly approach (electronics and optics sharing the same electrical package) can make it difficult to locate optical connectors which may require optical alignment to within a few microns, or less, of the active optical elements with which the optical connectors communicate.

### BRIEF DESCRIPTION OF THE DRAWINGS

For a more complete understanding of various examples, reference is now made to the following description taken in connection with the accompanying drawings in which:

FIG. 1A illustrates an example printed circuit board assembly (PCBA);

FIG. 1B illustrates a close-up view of arrays of example photodiodes and example vertical-cavity surface emitting lasers (VCSELs) of the example PCBA of FIG. 1A;

FIG. 2A illustrates a first perspective view of an example optical fiber assembly including an example optical connector and an example alignment collar in accordance with the disclosure;

FIG. 2B illustrates a second perspective view of the example optical fiber assembly of FIG. 2A;

FIG. 3 illustrates a perspective view of the example optical fiber assembly of FIGS. 2A and 2B and the example PCBA of FIG. 1;

FIG. 4 illustrates a cross-sectional view of a pair of example optical connectors releasably coupled to a pair of example alignment collars;

FIG. 5 illustrates a cross-sectional view of an example optical connector releasably coupled to an example alignment collar; and

FIG. 6 illustrates an example process of aligning optical devices and optical fiber connectors.

### DETAILED DESCRIPTION

Systems and methods described herein can provide an inexpensive, general platform for aligning optical connectors to optical elements (e.g., lasers and photodiodes) that may not have any other available reference. The systems and methods described herein may also allow the optical connector to be removed and reconnected multiple times without significant degradation of alignment accuracy.

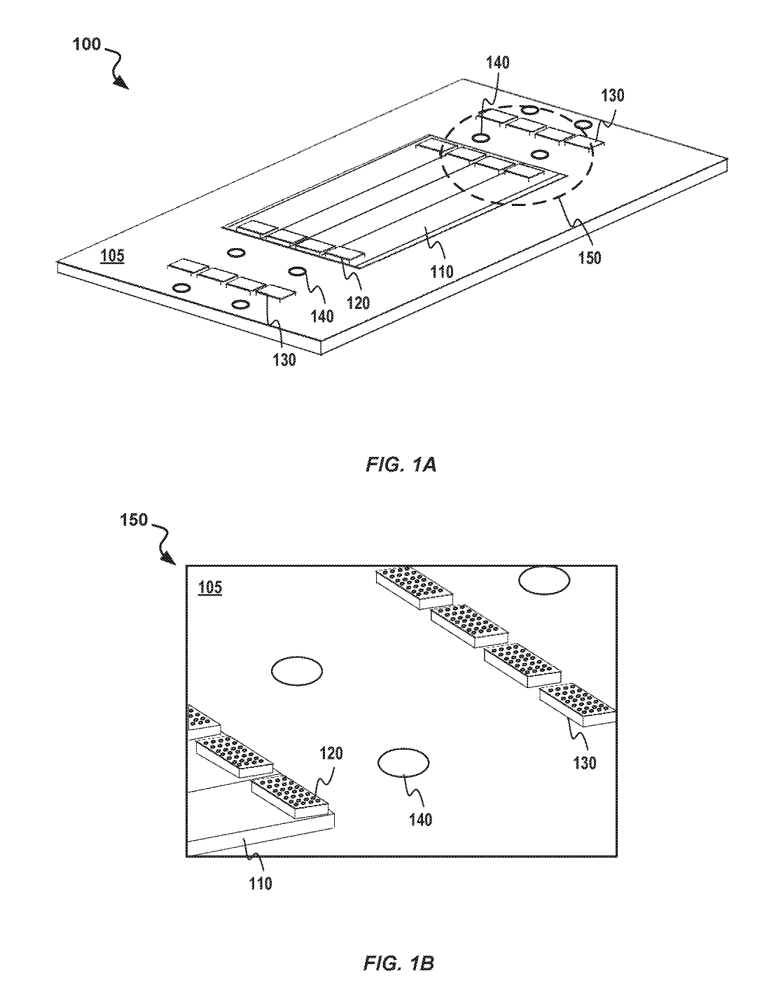

FIG. 1A illustrates an example printed circuit board assembly (PCBA) 100 including a central application specific integrated circuit (ASIC) 110 and arrays of photodiodes 120 and vertical-cavity surface-emitting lasers (VCSELs) 130 mounted, respectively, on the ASIC and a substrate 105. FIG. 1B illustrates a close-up view of the ASIC 110, the photodiodes 120 and the VCSELs 130 of FIG. 1A.

Alignment apertures 140 may be formed in the substrate 105. The alignment apertures 140 may be used to provide rough alignment features for mounting other devices on the substrate 105. These other devices may include, for example, alignment collars for optical fiber connectors in accordance with the present disclosure. For example, an alignment collar that provides precise alignment for an optical fiber connector could include alignment pins to be accepted by one or more of the alignment apertures. The optical fiber connector may be mounted above the VCSELs 130 in order to receive laser signals from the VCSELs and couple these laser signals to other parts of the PCBA 100 or to other devices connected to a fiber network, for example. In other examples, an optical fiber connector could be mounted above the photodiodes 120 in order to couple laser signals to the photodiodes 120.

Systems and methods described herein may provide practical, and low cost means for establishing a precise mechanical alignment reference between co-packaged optical devices and an optical fiber connector. For example, when photodiodes and VCSEL devices are attached directly to semiconductor chips as illustrated in FIGS. 1A and 1B, there may be no available reference (e.g., a mechanical reference) for referencing and attaching an optical connector. The systems and methods described herein can provide a general mechanical reference that can be precisely referenced with respect to optical element arrays flip chipped onto any surface, including integrated circuits (ICs), for example.

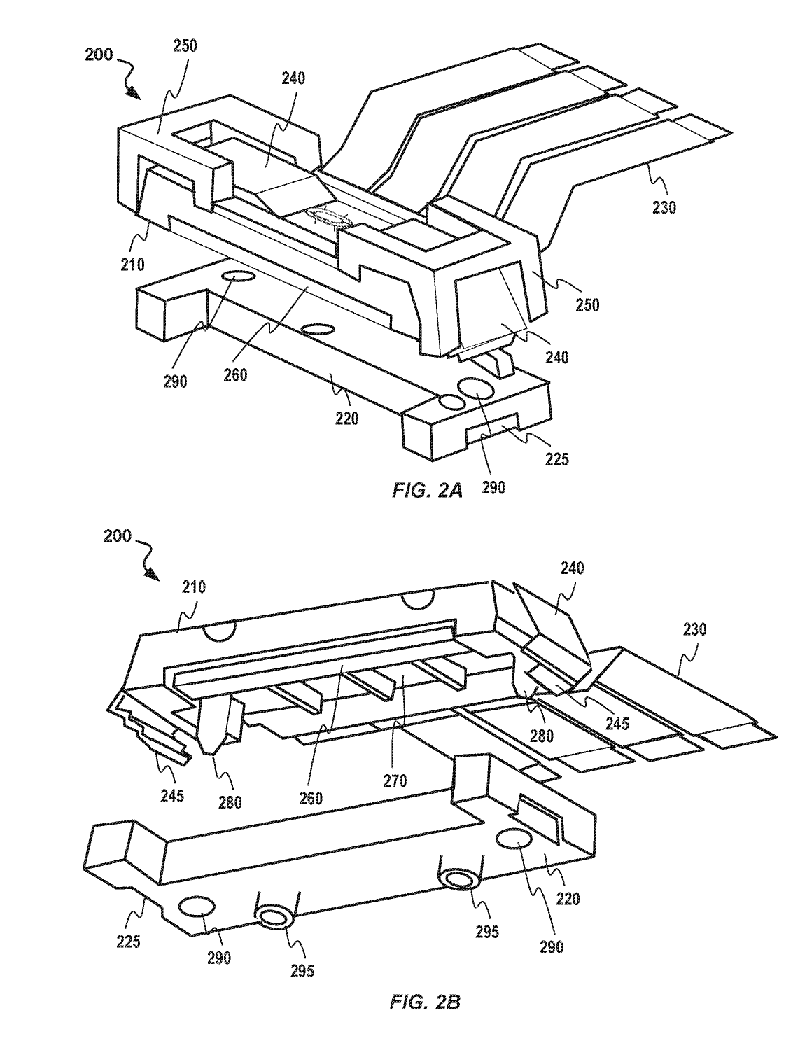

FIG. 2A illustrates a first perspective view of an example optical fiber assembly 200 including an example optical connector 210 and an example alignment collar 220 in accordance with the disclosure. FIG. 2B illustrates a second perspective view of the example optical fiber assembly 200 of FIG. 2A. The example optical connector 210 and the example alignment collar 220 are illustrated in a separated configuration in FIGS. 2A and 2B. One or more optical fibers, or ribbons 230 including multiple individual fibers, may be assembled into the example optical connector 210. The optical fiber ribbons 230 are coupled to the optical connector 210 via one or more precision locating features (for example, V-grooves 270) which may be formed into the connector body during fabrication, by a process such as injection molding or electro-forming, (see FIG. 2B). Exposed ends of the optical fiber cables 230 in the precision locating features 270 are precisely positioned and optically coupled to an optical interface portion 260 that is attached to the optical connector 210. The optical interface portion 260 may incorporate a variety of elements, such as refractive and diffractive lenses, spectral filters, and reflectors for example, to modify optical signals that are being communicated between the optical fibers and one or more optical devices such as the photodiodes 120 or the VCSELs 130 described above.

The optical connector is coupled to a releasable connector 240 with an interconnect frame 250. The example releasable connector 240 may be comprised of clips 245 to be accepted into voids 225 formed in the alignment collar 220. The clips 245 may be spring loaded such that when the optical connector is pressed onto the alignment collar 220, the clips 245 spread out to pass a portion of the alignment collar above the voids 225 and the clips are then held into the voids 220 by spring forces. Other forms of releasable connectors can be used instead of or in addition to the example releasable connector 240 illustrated in FIGS. 2A and 2B.

The optical connector 210 may include two connector alignment pins 280 that are positioned to be inserted into two collar apertures 290 formed in the alignment collar 220 when the optical connector 210 and the alignment collar 220 are releasably coupled via the releasable connectors 240. The underside of the alignment collar 220 may include two collar alignment pins 295 that may be positioned to be inserted into two of the alignment apertures 140 formed in the substrate 105 of the PCBA 100 of FIGS. 1A and 1B. In this regard, the collar alignment pins 295 and the alignment apertures 140 may be used for initial and/or rough alignment of the alignment collar 220 to the PCBA 100, for example. The alignment apertures may also serve as anchoring points for an adhesive to secure the alignment collar 220 to the PCBA 100. Further, the connector alignment pins 280 on the underside of the connector 210 and the collar apertures 290 may be used for precise alignment of the optical connector 210 to the alignment collar 220 in a releasable manner.

The connector alignment pins 280 of the optical connector 210 and the collar apertures 290 of the alignment collar 220 form one example of a high precision mechanical interface. Other mechanical interfaces besides the exemplary pin-in-hole mechanical interface of illustrated in FIGS. 2A and 2B may also be used. For example, other mechanical interfaces that may be used to precisely co-locate the optical connector 210 and the alignment collar may include a sphere-in-pit interface, a rod-in-groove interface, etc.

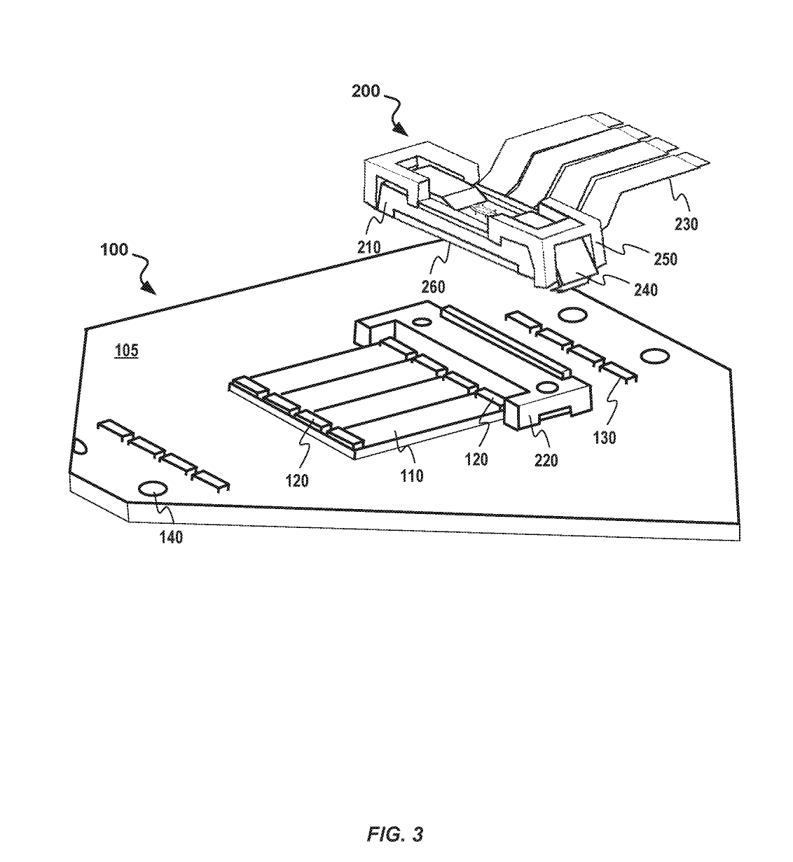

FIG. 3 illustrates a perspective view of the example optical fiber assembly 200 of FIGS. 2A and 2B and the example PCBA 100 of FIG. 1. In FIG. 3, the alignment collar 220 is shown attached to the substrate 105 while the optical connector 210 is decoupled from the alignment collar 220. In this illustration, the alignment collar 220 has been attached to the substrate 105 in the vicinity of the photodiodes 120. The alignment collar 220 may be attached while the optical connector 210 is releasably coupled to the alignment collar via the releasable connector 140. Alternatively, the alignment collar 220 may be attached to the substrate 105 while the optical connector 210 is separated from the alignment collar. During the attachment process, the collar alignment pins 295 may be inserted into a pair of the alignment apertures 140 that are provided in the substrate 105 near the photodiodes 120.

During the optical alignment process, the alignment collar 220 may be brought into precise position (for example, less than 10-micron position error for multi-mode optical communication and less than 1-um error for single-mode optical communication) with respect to the photodiodes 120 or VCSELs 130 and fixedly attached to the substrate 105 with, for example, a rapid curing material such as light cure glue or solder. The alignment collar can be positioned by a variety of processes including, but not limited to: i) passive alignment, in which precision parts may be snapped or otherwise securely positioned together, and precision alignment is achieved by the fit of the parts; ii) vision-aided alignment wherein positioning information may be provided by visual devices such as cameras, and; iii) active alignment, wherein active devices, such as lasers, are electrically energized to provide a light signal, and the optical connector is moved systematically with respect to the light signal to enable a measuring device such as an optical power meter connected to one or more of the optical fibers in the connector to determine that an optimum position has been reached. In the case of active optical alignment, the optical connector 210 and the alignment collar 220 can be aligned to the optical arrays (e.g., the photodiodes 120 or the VCSELs 130) and the alignment collar 220 can be attached to the substrate 105. Alternatively, in the case of passive and vision aided alignment, the alignment collar 220 can be aligned independently and attached to the substrate 105. The optical connector 210 can then be detached from the alignment collar 220 and removed. Secondary material may be added to strengthen the bond between the alignment collar 220 and the substrate 105.

Subsequent to the optical connector 210 being detached from the alignment collar 220, the PCBA 100 can be subjected to additional processing, such as solder attach, without the unwieldy and thermally sensitive optical fiber cables 230 and the optical connector 210 being attached. At an appropriate time, the optical connector 210 can be reattached to the alignment collar 220, thereby reestablishing precise alignment between the active devices (e.g., the photodiodes 120 and/or the VCSELs 130) and optical fibers assembled within the optical connector 210.

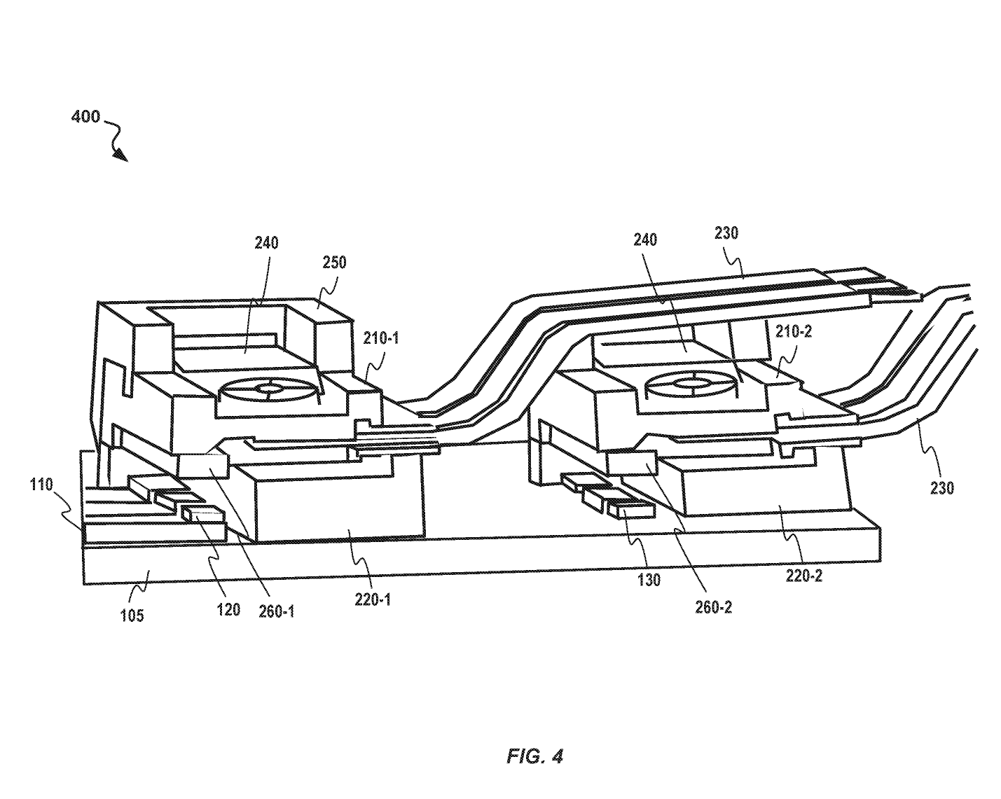

FIG. 4 illustrates a cross-section view 400 of a pair of optical connectors 210-1 and 210-2 releasably coupled to a pair of alignment collars 220-1 and 220-2, respectively. The optical connector 210-1 may be aligned above the arrays of photodiodes 120 and the optical connector 220-1 may be aligned above the VCSELs 130. The alignment color 220-1 can be configured with a thickness (measured perpendicular to the substrate 105) that provides a precise separation between the photodiodes 120 and an optical interface 260-1 that is coupled to the optical connector 210-1. Similarly, the alignment color 220-2 can be configured with a thickness (measured perpendicular to the substrate 105) that provides a precise separation between the VCSELs 130 and an optical interface 260-2 that is coupled to the optical connector 210-2.

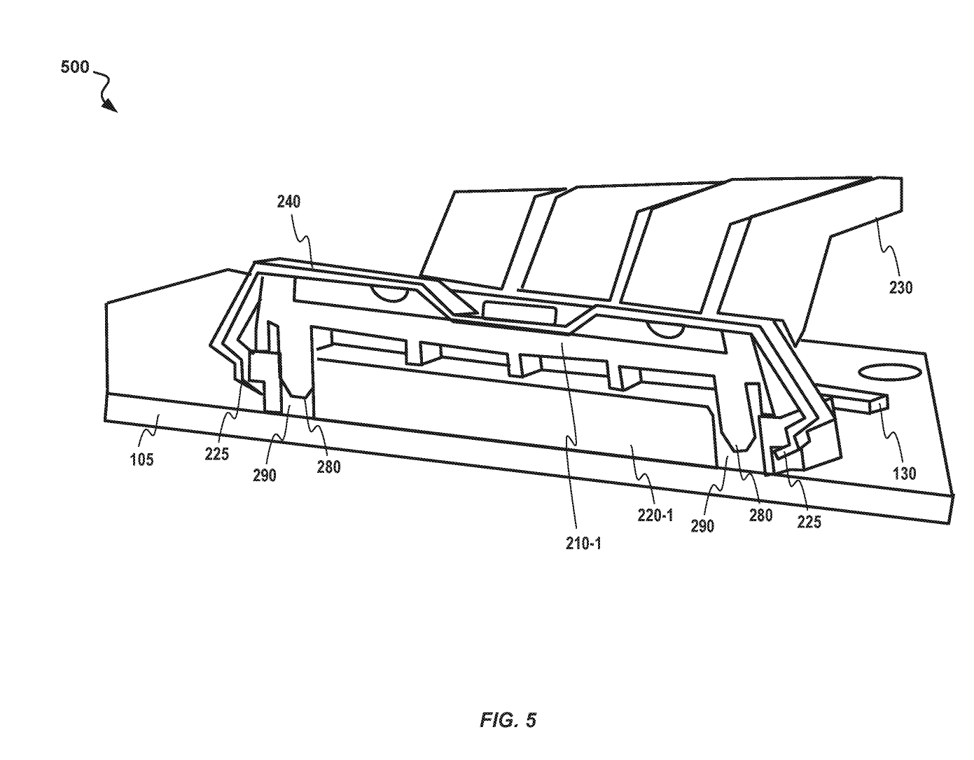

FIG. 5 illustrates a cross-section view 500 of the optical connector 210-1 releasably coupled to the alignment collar 220-1. As can be seen, the connector alignment pins 280 can be positioned within the collar apertures 290 when the optical connector 210-1 is releasably attached to the alignment collar 220-1.

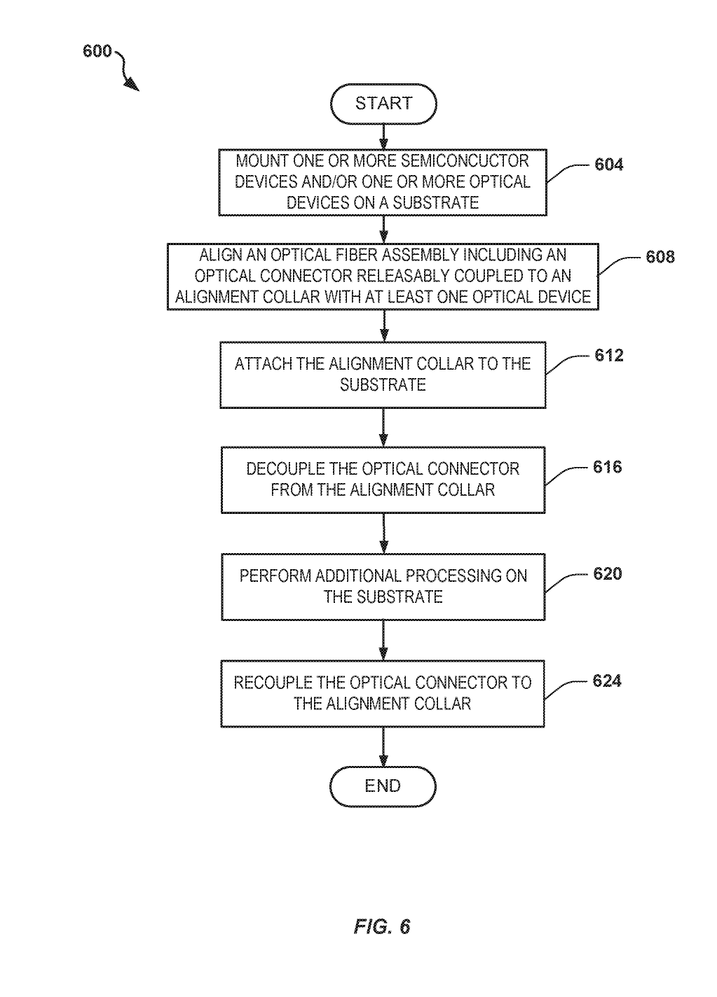

FIG. 6 illustrates an example process 600 of aligning optical devices and optical fiber connectors. In various examples, the process 600 may be performed to align the optical connector 210 with one or more optical elements, such as, for example, the photodiodes 120 and/or the VCSELs 130 and to attach one of the alignment collars 220 to the substrate 105 of the PCBA 105, as described above in reference to FIGS. 1-5. The process 600 will now be described in reference to FIGS. 1A, 1B, 2A and 2B.

In the example illustrated in FIG. 6, the process 600 may begin with the mounting of one or more semiconductor devices and/or one or more optical devices on a substrate (block 604). For example, the ASIC 110 and the VCSELs 130 may be mounted to the substrate 105. Photodiodes 120 may be mounted, in flip-chip fashion, for example, to the ASIC 110.

Upon the semiconductor devices and/or optical devices being mounted on the substrate, the optical fiber assembly 200 including the optical connector 210 releasably coupled to the alignment collar 220 may be aligned with an optical device (e.g., the photodiodes 120 and/or the VCSELs 130) (608). The alignment may be performed, in a first example, while the optical connector 210 is coupled to the alignment collar 220. The alignment may be performed, in a second example, while the optical connector 210 is detached from the alignment collar 220. The alignment process may involve an active aligning process that may involve putting a signal through the optical fiber cables 230 while the optical connector 210 is releasably coupled to the alignment collar 220. The alignment may also involve a vision-aided aligning using, for example, a camera. The alignment may also involve a passive aligning using a mechanical feature on the substrate 105, for example.

At block 612, after the alignment at block 608, the alignment collar 220 may be fixedly attached to the substrate 105. The attachment at block 612 may involve applying an adhesive around a perimeter of the alignment collar 220, for example.

At block 616, the optical connector 210 may be decoupled from the alignment collar 220. Upon decoupling the optical connector 210, additional processing on the components of the PCBA 100 may be performed at block 620. With the optical connector 210 and the optical fiber cables 230 removed, the processing at block 620 may be performed with less interference. At an appropriate time, at block 624, the optical connector 210 may be recoupled to the alignment collar.

The functions performed at blocks 604-624 may be repeated until all semiconductor devices, optical devices and optical fiber assemblies have been attached to the substrate 105 and/or to ICs. The process 600 illustrated in FIG. 6 is an example only and not limiting. In various examples, the process 600 may be altered, for example, by having steps or blocks added, removed, rearranged, combined, and/or performed concurrently.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. which may be designed to perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. An apparatus, comprising:
an optical connector coupled to at least one optical fiber;
an optical interface coupled to the optical connector and to the at least one optical fiber, the optical interface to receive or transmit an optical signal; and
an alignment collar releasably coupled to the optical connector and coupled to a substrate, wherein the optical interface is in alignment with at least one optical device coupled to an integrated circuit or the substrate.

2. The apparatus of claim 1, further comprising a releasable connector coupled to the optical connector and releasably attached to the alignment collar.

3. The apparatus of claim 1, wherein the optical connector comprises at least a first alignment pin and the alignment collar comprises at least a first aperture to accept the first alignment pin when the optical connector is releasably coupled to the alignment collar.

4. The apparatus of claim 1, wherein the alignment collar comprises at least a second alignment pin positioned in an aperture formed in the substrate when the alignment collar is coupled to the substrate.

5. A method, comprising:
aligning an optical fiber assembly with at least one optical device mounted on an integrated circuit or a substrate, the optical fiber assembly comprising:
an optical connector, and
an alignment collar releasably coupled to the optical connector;
subsequent to aligning the optical fiber assembly, fixedly attaching the alignment collar to the substrate; and
decoupling the optical connector from the alignment collar.

6. The method of claim 5, wherein fixedly attaching the alignment collar comprises applying an adhesive around a perimeter of the alignment collar.

7. The method of claim 5, further comprising, subsequent to decoupling the optical connector, performing additional processing on the substrate.

8. The method of claim 7, further comprising, subsequent to performing the additional processing, recoupling the optical connector to the alignment collar.

9. The method of claim 7, wherein performing additional processing on the substrate comprises attaching one or more semiconductor or passive electrical devices to the substrate.

10. The method of claim 5, further comprising:
mounting the at least one optical device on the integrated circuit or substrate, wherein the optical device comprises at least one of a photodiode, a flip-chip photodiode, a laser and a vertical-cavity surface-emitting laser (VCSEL) and a flip-chip VCSEL.

11. The method of claim 5, wherein the optical connector is coupled to at least one optical fiber and aligning the optical fiber assembly comprises performing at least one of active aligning using an optical signal in the optical fiber cable, passive aligning using a mechanical feature on the substrate and vision-aided aligning using a camera.

12. The method of claim 5, wherein the at least one optical device is a photodiode assembled in flip-chip fashion over an application specific integrated circuit (ASIC) and aligning the optical fiber assembly comprises aligning an optical interface of the optical connector above the photodiode.

13. A printed circuit board assembly, comprising:
a substrate or an integrated circuit;
an optical device coupled to the integrated circuit or the substrate;
an alignment collar fixedly coupled to the substrate; and
an optical fiber assembly comprising:
an optical connector coupled to at least one optical fiber cable, the optical connector to be releasably coupled to the alignment collar; and
an optical interface coupled to the optical connector and the at least one optical fiber cable, the optical interface to perform at least one of receive an optical signal from the optical device and transmit an optical signal to the optical device when coupled to the alignment collar.

14. The printed circuit board assembly of claim 13, wherein the optical device is a flip-chip photodiode coupled to an application specific integrated circuit (ASIC).

15. The printed circuit board assembly of claim 13, wherein the optical device is a vertical-cavity surface-emitting laser (VCSEL) or a flip-chip VCSEL.
